(19) United States
(12) Patent Application Publication
(10) Pub. No.: US 2020/0132606 A1
(43) Pub. Date: Apr. 30, 2020

(54) SYSTEMS AND METHODS FOR RAPID ELEMENTAL ANALYSIS OF AIRBORNE PARTICLES USING ATMOSPHERIC GLOW DISCHARGE OPTICAL EMISSION SPECTROSCOPY

(71) Applicants: Pramod P. Kulkarni, Bethesda, MD (US); Lina Zheng, Bethesda, MD (US)

(72) Inventors: Pramod P. Kulkarni, Bethesda, MD (US); Lina Zheng, Bethesda, MD (US)

(73) Assignee: The USA, as represented by the Secretary, Department of Health and Human Services, Bethesda, MD (US)

(21) Appl. No.: 16/500,925

(22) PCT Filed: Apr. 11, 2018
(86) PCT No.: PCT/US2018/027105

§ 371 Date: Oct. 4, 2019

Related U.S. Application Data
(60) Provisional application No. 62/484,300, filed on Apr. 11, 2017.

(51) Int. Cl. G01N 21/68; G01N 15/02; G01N 21/67

(52) U.S. Cl. CPC G01N 21/68; G01N 15/0266; G01N 2201/0221; G01N 2015/0261; G01N 15/0255; G01N 21/67

(57) ABSTRACT

The present disclosure relates to systems and methods for performing elemental analysis of airborne aerosols. The systems comprise an aerosol collection device for accumulating aerosol particles in a flow of aerosol particles, a radio frequency power supply for providing a glow discharge current to ablate the aerosol particles accumulated in the aerosol collection device, and an optical emission spectrometer or a mass spectrometer for analyzing elements in the ablated aerosol particles. Several types of aerosol collection devices are described.

### RELATED APPLICATIONS

The present application claims priority to U.S. Provisional Patent Application No. 62/484,300, entitled “Systems and Methods for Rapid Elemental Analysis of Airborne Particles Using Atmospheric Glow Discharge Optical Emission Spectroscopy,” filed Apr. 11, 2017, the entire contents of which are incorporated herein by reference.

### FIELD OF THE PRESENT DISCLOSURE

The present invention relates generally to methods and apparatus for the collection and analysis of aerosol particles.

### BACKGROUND OF THE PRESENT DISCLOSURE

Airborne particles affect the global climate, air quality, and human health. In particular, long-term inhalation of toxic particulate matter could pose a significant health risk to those who are routinely exposed to airborne particles, such as those in occupational environments. Measurement of exposure to metals is essential to environmental and occupational health studies.

The existing aerosol analysis methods require particle collection on filters over several hours, followed by subsequent laboratory analysis, which is labor- and time-intensive. Low-cost, field portable, near real-time instruments for chemical analysis of aerosol are desired to address these limitations. Several plasma-based techniques have been used for elemental analysis of aerosols, which have employed excitation sources such as spark microplasma, laser-induced microplasma, and microwave-induced plasma. However, the excitation sources used in these methods can be bulky and costly, making them unsuitable for hand-held, low-cost monitors for aerosol elemental analysis.

In this context, the glow-discharge excitation sources offer attractive alternatives for development of low-cost aerosol instruments. Solution-cathode glow discharge (SCGD) and liquid sampling—atmospheric pressure glow discharge (LS-APGD) have been developed for elemental analysis of liquid solutions. These techniques can offer similar detection limits (tens of parts per billion) as ICP-AES, but have the advantage of much lower cost and power consumption. Others have conducted elemental analysis of aerosols by a direct injection of particles into a low-pressure glow discharge plasma through an aerodynamic lens system, and obtained limits of detection (LOD) on the order of tens of nanograms. However, the aerodynamic lens method required use of large vacuum pumps to create particle beams for direct injection into glow discharge, making it unsuitable for hand-held instrumentation.

### SUMMARY OF THE PRESENT DISCLOSURE

The present disclosure generally relates to systems and methods for a new, low-cost approach based on application of atmospheric radio frequency glow discharge optical emission spectroscopy (rf-GD-OES) for near real-time measurement of elemental concentrations in airborne particulate matter. This method involves deposition of aerosol particles on the tip of a grounded electrode of a coaxial microelectrode system, followed by atomization and excitation of the particulate matter using the rf-GD. In other embodiments, the method may involve accumulating or micro-concentration of an aerosol analyte on an electrode tip. The particulate analyte is then atomized and excited using an atmospheric glow discharge initiated in an argon bath between the electrode tip and another coaxial electrode. Regardless of the configuration, the resulting atomic emissions are captured and analyzed using a spectrometer. In one aspect, the glow discharge plasma may be characterized by a gas temperature (375-1500 K) and electron density (2-5×10¹⁴ cm⁻³).

In another aspect, the method provides limits of detection in the range of 0.055-1.0 ng in terms of absolute elemental mass. In another aspect, the method may be scaled down for performance using a portable aerosol elemental spectrometry device.

In one embodiment, a portable system for the spectroscopic analysis of aerosol particles has an aerosol collection device that further includes a housing defining an inlet and an outlet, a corona electrode disposed proximally to the inlet, and a ground electrode disposed proximally to the outlet. The ground electrode is aligned coaxially with the corona electrode and is separated from the corona electrode by a gap. The system also includes a high voltage source in communication with the corona electrode and a radio frequency power supply in communication with the corona electrode. The corona electrode is held at a bias voltage provided by the high voltage source. The glow discharge is generated at the corona electrode by the radio frequency power supply, and the glow discharge ablates aerosol particles collected on the ground electrode.

In another embodiment, a portable system for the spectroscopic analysis of aerosol particles includes an aerosol collection device to accumulate aerosol particles in a flow of aerosol particles and a radio frequency power supply to provide a glow discharge current to ablate the aerosol particles accumulated in the aerosol collection device. The system also includes an optical emission spectrograph system to analyze an emission spectrum from the ablated aerosol particles.

In yet another embodiment, a portable system for the spectroscopic analysis of aerosol particles includes an aerosol collection device that further includes a dielectric substrate, a cathode electrode positioned on the dielectric substrate, and an anode electrode positioned on the dielectric substrate and aligned with the cathode electrode. The anode electrode is separated from the cathode electrode by a gap defining a particle deposition area. The system also includes a radio frequency power supply in communication with the anode electrode, wherein a glow discharge is generated at the anode electrode by the radio frequency power supply. The glow discharge ablates aerosol particles collected in the particle deposition area.

In one embodiment, a portable system for the spectroscopic analysis of aerosol particles includes an aerosol collection device further having a ground electrode and a high-voltage electrode assembly for particle separation, wherein the high-voltage electrode is disposed facing the ground electrode and separated by a separation gap. The aerosol collection device further comprises one or more pairs of glow discharge electrodes, wherein the glow discharge electrodes comprise an anode electrode and a cathode electrode positioned on the ground electrode and wherein the anode electrode is aligned with a cathode electrode positioned on the ground electrode and separated from the cathode electrode by a gap defining a particle deposition area. The system further includes a radio frequency power supply in communication with each anode electrode of glow discharge electrodes pairs. The glow discharge is generated at each anode electrode by the radio frequency power supply, and the glow discharge ablates aerosol particles collected on the ground substrate in the particle deposition area.

In another embodiment, a portable system for the spectroscopic analysis of aerosol particles includes an aerosol collection device further having a dielectric housing defining one or more stages where each stage is separated by a micro-orifice inlet. The collection device also includes a cathode electrode positioned within each of the one or more stages of the dielectric housing and an anode electrode positioned proximal to the micro-orifice inlet of each stage and aligned facing the cathode electrode. The anode electrode is separated from the cathode electrode by a gap defining a particle deposition area. The system also includes a radio frequency power supply in communication with the anode electrode. A glow discharge is generated at the anode electrode by the radio frequency power supply and ablates aerosol particles collected in the particle deposition area.

In one embodiment, a method of performing an aerosol analysis in a portable apparatus includes providing a housing having an inlet and an outlet, wherein the aerosol particles flow from the inlet to the outlet. The method further includes applying a bias voltage to a corona electrode positioned near the inlet and in a flow path of the aerosol particles and holding a ground electrode to a ground potential, wherein the ground electrode is coaxial with the corona electrode, positioned near the outlet, and spaced from the corona electrode by a gap. The method further includes providing a constant flow of the aerosol particles to the housing, providing a glow discharge current to the corona electrode using a radio frequency power supply, wherein the glow discharge ablates aerosol particles accumulated on the ground electrode, collecting emissions produced by the ablation of the accumulated aerosol particles, and analyzing an emissions spectrum of the ablated aerosol particles.

In another embodiment, a method of performing an aerosol analysis in a portable apparatus includes providing a housing having multiple stages, each stage comprising an inlet and an outlet, and wherein the aerosol particles flow from the inlet to the outlet. The method further includes applying a bias voltage to one or more anode electrodes positioned near each inlet and in a flow path of the aerosol particles and holding one or more cathode electrodes to a ground potential, wherein a cathode electrode is disposed within each stage and spaced from the anode electrode by a gap defining a particle deposition area in each stage. The method further includes providing a constant flow of the aerosol particles to the housing and providing a glow discharge current to the cathode electrode using a radio frequency power supply, where the glow discharge ablates aerosol particles accumulated in each particle deposition area of each stage. The method also includes collecting emissions produced by the ablation of the accumulated aerosol particles in each stage; and analyzing an emissions spectrum of the ablated aerosol particles.

### BRIEF DESCRIPTION OF FIGURES

The present patent or application file contains at least one drawing executed in color. Copies of this patent or patent application publication with color drawing(s) will be provided by the Office upon request and payment of the necessary fee.

FIG. 1 is a schematic diagram of the system for rapid elemental analysis according to one embodiment.

FIG. 2 is a Table of Materials used to generate calibration aerosol for various embodiments of the aerosol analysis system.

FIG. 3 includes graphs of variances of gas temperature (a) and electron density (b) as a function of inter-electrode distance for the aerosol analysis system according to one embodiment.

FIG. 4 includes graphs according to various embodiments of the aerosol analysis system for (a) and (b): Space-resolved rf-GD-OES spectra acquired along the axis of the glow discharge plasma in the absence of analytes on the collection electrode; (c) and (d): the spectrum acquired at the collection electrode tip corresponding to (a) and (b) respectively.

FIG. 5 includes graphs of (a) Time-resolved rf-GD-OES spectra acquired between 0 and 4 seconds after the glow discharge was initiated in the presence of particles on the collection electrode tip; (b) the spectrum acquired at t=0 s; and (c) the spectrum acquired at t=4 s, according to one embodiment.

FIG. 6 is a graph of Space-resolved rf-GD-OES spectra acquired along the axis of the glow discharge plasma in the presence of particles on the collection electrode according to one embodiment.

FIG. 7 is a graph of Changes in temperature at the electrode with time when glow discharge was on or off, according to one embodiment.

FIG. 8 is a graph of variations of Ar I and Pt I signal intensity as a function of time during a single glow discharge event according to one embodiment.

FIG. 9 is a graph of the change in signal response for different particulate carbon mass with glow discharge time according to one embodiment.

FIG. 10 is a graph of Calibration curves for C, Cd, Na and Mn obtained using the aerosol analysis system according to one embodiment.

FIG. 11 is a table showing a comparison of limits of detection for various embodiments of the aerosol analysis system with other aerosol measurement methods using microplasma spectroscopy.

FIGS. 12A and 12B are a top view and cross-sectional view as viewed along line A-A, respectively, of a dielectric substrate with deposited particles according to one embodiment.

FIGS. 13A-B are a top view and a side view, respectively, of a multiplexed configuration of the electrode system, shown in FIGS. 12A-B, according to one embodiment.

FIG. 14 is a side view of a multiplexed configuration of the electrode system according to one embodiment.

FIG. 15 is a cross-sectional view of an embodiment of portions of the aerosol analysis system having a cascade impaction system that separates particles based on their aerodynamic size, according to one embodiment.

FIG. 16 is a schematic illustration of the aerosol analysis system according to one embodiment.

FIG. 17 is a graph illustrating voltage and current waveforms of the radio frequency glow discharge in argon gas at atmospheric pressure using a radio frequency power supply, according to one embodiment.

### DETAILED DESCRIPTION

Glow discharge, as an excitation source for elemental determination, has unique advantages with respect to development of hand-held sensors such as low cost, low temperature, low power consumption, and analytical versatility. Glow discharge optical emission spectroscopy (GD-OES) and glow discharge mass spectroscopy (GD-MS) have been applied to the bulk elemental analysis of inorganic solid samples and quantitative depth profile analysis. In a glow discharge system, the samples function as the cathode. The samples are continuously eroded by bombardment of ions and neutral atoms or molecules of the plasma. The free atoms ejected from the samples are diffused into the plasma plume, where they are excited through collisions with electrons, metastable gas atoms and ions, leading to element specific optical emission.

One aspect of the systems and methods of the present disclosure provides near real-time method analysis of aerosol elementals using a low-cost atmospheric radio frequency glow discharge (rf-GD) excitation source. In another aspect, a corona-based micro-concentration method is used for microscopic collection of airborne particles, followed by elemental analysis using radio frequency glow discharge optical emission spectroscopy (rf-GD-OES). In various embodiments, the systems and methods are configured for automated and semi-continuous analysis of aerosol. The rf-GD-OES aerosol analysis system 10 has robust spectral features and signal stability . In one aspect, the glow discharge plasma may be characterized by measuring its gas temperature and electron density using suitable spectroscopic methods.

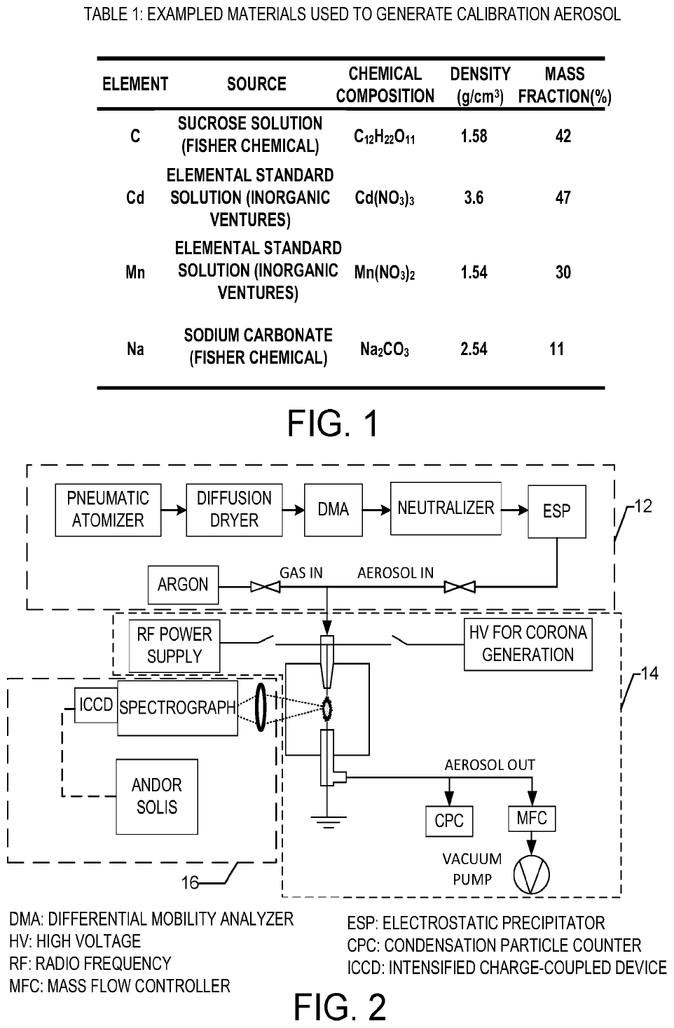

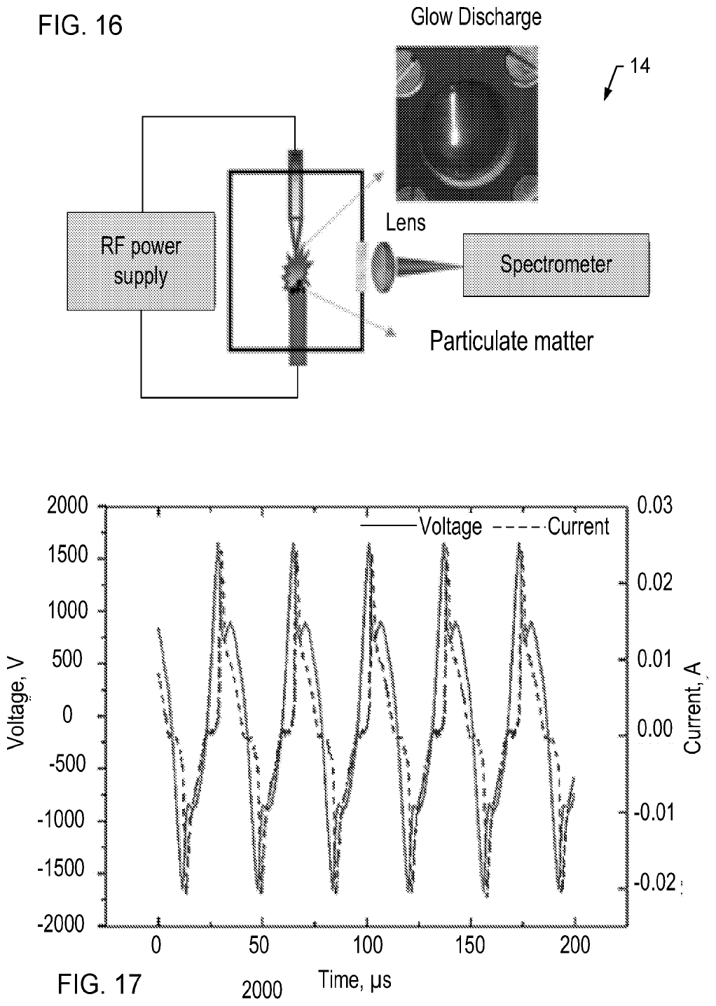

A schematic diagram of the experimental setup for one embodiment of aerosol analysis system 10 for the collection and analysis of aerosol or airborne particles is shown in FIG. 1. As shown, the aerosol analysis system 10 includes subsystems such as: (i) an aerosol generation system generally indicated as 12, (ii) an aerosol collection system, indicated generally as 14, and (iii) a radio frequency glow discharge optical emission spectroscopy (rf-GD-OES) system, indicated generally as 16. The aerosol generation and collection systems were similar to those described in previously published studies. A simplified schematic of an embodiment of the aerosol collection system 14 is shown in FIG. 16. While FIG. 1 identifies various components of the aerosol generation system 12, the aerosol collection system 14, and the rf-GD-OES system 16, the specific machinery, components, models, and manufactures disclosed herein are provided solely for reference and do not necessarily limit the scope of the disclosure to the particular components referenced.

### Aerosol Generation System

In various embodiments, the aerosol generation system 12 includes a pneumatic atomizer 20 to atomize solutions containing analytes. By way of example and not limitation, the pneumatic atomizer 20 may be a Model 3080 pneumatic atomizer, manufactured by TSI Inc., of Shoreview, Minn., USA. The atomized particles are then passed through a diffusion dryer 22. After the dryer 22, a differential mobility analyzer (DMA) 24, a neutralizer 26, and an electrostatic precipitator (ESP) 28 were used to obtain a near monodispersal of uncharged particles for calibration purposes. By way of example, in one embodiment, 100 nm diameter particles classified by the DMA were used for calibration. As shown in FIG. 2, materials containing C, Na, Cd, and Mn were used for calibration, in one embodiment. Further calibration was performed using stock standard solutions containing desired elements. The solutions were diluted using ultra-filtered deionized water to obtain calibration solutions, ranging from 100 to 1000 μg /mL depending on the analyte.

### Aerosol Collection System

The test aerosol particles were then introduced into a corona aerosol micro-concentrator (CAM) 30. In one embodiment, the CAM 30 consists of two coaxial electrodes XXX 32A-B with an inter-electrode distance 34 of 4 mm. A high positive voltage potential (−5 kV) was applied to the corona electrode 32A by a DC power supply 36. By way of example and not limitation, the DC power supply may be a Bertran S-230 power supply manufactured by Spellman Corp., of Hauppauge, New York. In one embodiment, the corona electrode 32A may be composed of tungsten, has a shaft diameter of approximately 200 μm, and has a tapered tip 38 with an approximate radius of 50 μm. The ground electrode 32B may be composed of platinum, has a diameter of approximately 500 μm, and has a relatively flat tip 40 to provide a planar surface for particle deposition. The aerosol particles entering the CAM 30 were collected on the tip of the ground electrode 32B. In various embodiments, the sidewalls of the ground electrode 32B are covered with a high dielectric strength sheath. By way of example and not limitation, the sheath may be composed of polyether ether ketone (PEEK) and has an outer diameter of approximately 1.58 mm and a wall thickness of approximately 0.40 mm. The flat tip 40 of the ground electrode 32B was bare to allow aerosol sample collection.

The CAM electrodes 32A-B are also used to produce a radio-frequency glow discharge at the tip 38 of the collection electrode 32A. The glow discharge is provided by a RF power supply 42. By way of example and not limitation, the RF power supply may be a mode; PVM500 RF power supply manufactured by Information Unlimited, of Amherst, N.H. In one embodiment, the RF power supply provides a maximum output voltage of approximately 1.6 kV at a frequency of 27.6 kHz. Similar power supplies producing greater and lesser output voltages at a range of frequencies may also be used. In various embodiments, it is desirable to use an inexpensive, compact, lightweight, power supply that consumes low power, such that the aerosol analysis system 10 may be configured as a portable hand-held instrument.

As shown in FIG. 1, the glow discharge generated in the CAM 30 was produced in an argon atmosphere. While the system 10 and associated methods of use are described in associate with an argon gas environment, other suitable gases including, but not limited to other noble gases may be used. After the particle collection, the pre-purified argon gas is introduced into the chamber. In one embodiment, the gas is introduced at atmospheric pressure at a constant flow rate of 0.9 L/ min.

Once the glow discharge was initiated, the collected particulate matter on the ground electrode surface 40 was ablated over a period of time that may range from microseconds to 10 seconds. In one aspect, the time required for complete ablation of the sample depends on the particle mass. The measured voltage and current waveforms for the inter-electrode distance in the CAM 30 for one embodiment of the system 10 are shown in FIG. 17.

A constant flow rate of 1.5 L/min of aerosol was maintained through the CAM 30 and was driven by the internal pump of a condensation particle counter (CPC) 44. In one embodiment, the CPC 44 may be the model 3022A CPC manufactured by TSI Inc., of Shoreview, Minn. Moreover, the overall flow parameters of the aerosol analysis system 10 may be controlled using a mass flow controller (MFC) 46, such as but not limited to the Model 247 C MFC manufactured by MKS Instruments, Inc., of Andover, Mass., in communication with a vacuum pump 47.

To analyze the composition of the aerosol collected in the CAM 30, the glow discharge from within the inter-electrode gap is focused towards a spectrograph 48 using a lens 50. In one embodiment, the spectrograph 48 may be an IsoPlane SCT320 spectrograph manufactured by Princeton Instrument Inc., of Trenton, N.J. Similarly, in one embodiment, the lens 50 may be a UV-grade plano-convex lens having a focal length of approximately 50 mm. The spectrograph 48 may be coupled with a gated intensified charge-coupled device (ICCD) 52, such as but not limited to the iStar 334T manufactured by Andor Technology of South Windsor, Connecticut. In one embodiment, the multi-track mode of the ICCD may record the space-resolved spectra, and the kinetic mode may be used to record the time-resolved spectra. The data from the spectrograph 48 and ICCD 52 may be recorded at a computing device or processor 54 to yield space- and time-resolved emission spectra from the glow discharge during the particulate sample ablation. In various embodiments, wavelength calibration was achieved using an Hg—Ar lamp, while triggering of the spectrograph, RF power supply and data acquisition at the computing device or processor 54 were controlled through the built-in digital delay generator in the ICCD. Other suitable means for triggering the spectrograph, RF power supply and data acquisition may also be used.

### Example Method of Calibration

One embodiment of a calibration method 400 for calibrating the aerosol analysis system 10 is in FIG. 18. The calibration method 400 includes generating test aerosols at 402 and collecting of the aerosol particles on the flat tip 40 of the ground electrode 32B for predetermined amount of time at 404. The collected particles are ablated by glow discharge at 406 and the time-resolved emission spectra during glow discharge is recorded at 408. The emission signal for a particular analyte of interest for each spectrum is calculated at 410, while the time-integrated signal intensity for the particular analyte of interest is calculated at 412. Lastly, the calibration curve by plotting the integrated signal intensity as a function of analyte mass is constructed.

The following Equation (1) is used to determine the particulate mass deposited on the electrode for the known diameter of particles:

$${m}_{p} = η {C}_{i n} {Q}_{f} {t}_{c} {ρ}_{p} \frac{π}{6} {d}_{v}^{3} ; \qquad ( 1 )$$

where η is the capture efficiency of particles, Cᵢₙ is the particle concentration flowing into the chamber, Q_{f} is the aerosol volumetric flow rate, t_{c}, is the particle collection time, p_{ρ} is the particle material density, and dᵥ, is the volume equivalent particle diameter. Assuming the particles are spherical, the volume equivalent diameter is equal to the electrical mobility diameter.

Equation (2) was used to determine the particle capture efficiency. More specifically, the particle capture efficiency was calculated by measuring the particle number concentration downstream of the collection unit using a CPC, with or without the presence of the electric field across the electrodes (Nₒᵤₜ^{V=0} and Nₒᵤₜ^{HV}):

$$η = \frac{{N}_{out}^{V = 0} - {N}_{out}^{HV}}{{N}_{out}^{V = 0}} . \qquad ( 2 )$$

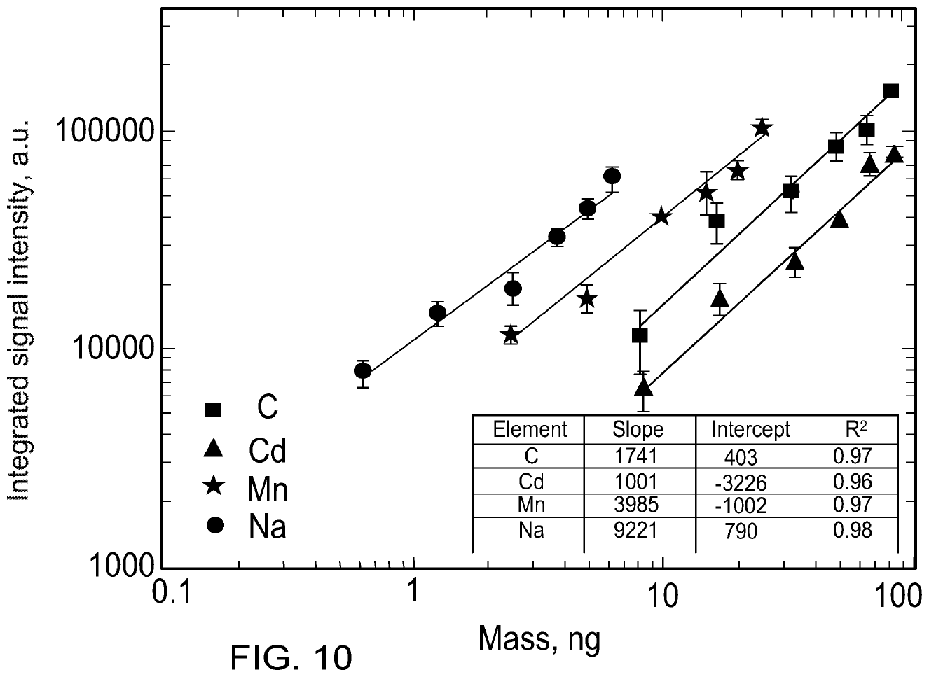

Particulate elemental mass loadings on the ground electrode of 1 to 100 ng were achieved by varying the collection time. For each mass loading, three replicate measurements were performed and the final calibration curve was constructed by averaging over the three independent sets of measurements. The atomic emission from glow discharge was recorded kinetically with a gate width of 500 ms during a total cumulative period of 10 seconds for individual measurement. The total emission signal from the target analyte with known mass was obtained by adding the time-dependent signal over the life of the glow discharge. The calibration curve, as shown in FIG. 10, was constructed by plotting the total signal intensity as a function of mass loaded on the collection electrode.

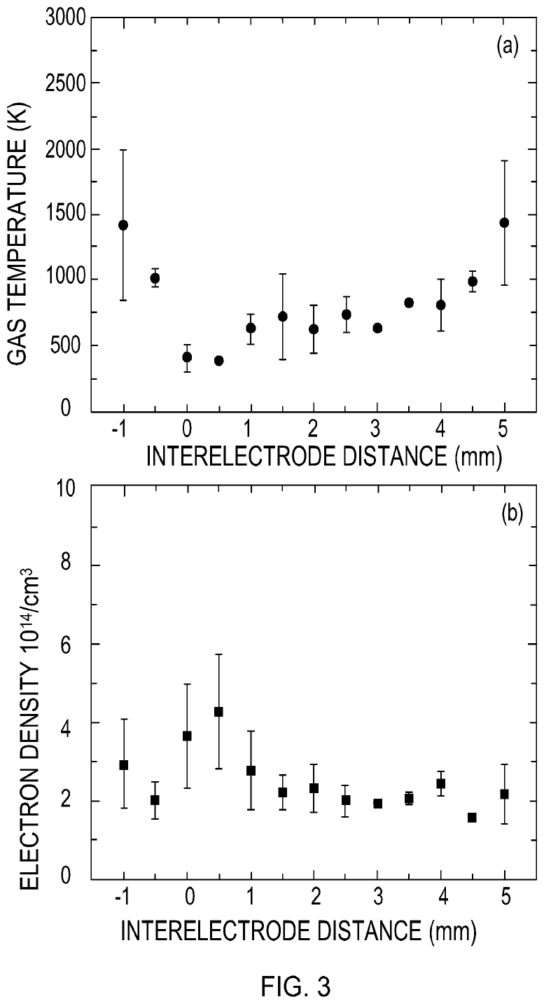

In various embodiments, the gas temperature of the glow discharge is in a range between about 200-1200 K. By way of example, FIG. 3(a) is a graph of the gas temperature as a function of inter-electrode distance on the x-axis, according to various embodiments. FIG. 3(b) illustrates the electron density plotted as a function of inter-electrode distance, according to various embodiments. The electron density reaches a maximum close to the cathode surface (negative glow region), and then decreases with the distance from the cathode. In various embodiments, inter-electrode distance may be in a range between about 2 mm and 6 mm. This trend agrees well with the prediction of a one-dimensional model of an argon micro discharge. The electron density of the rf-GD system of the present disclosure was on the order of 10¹⁴ cm⁻³, which was consistent with the electron density of similar plasmas reported in the literature. However, as expected, electron density induced by glow discharge is lower by 3 to 5 orders of magnitude compared to that in a pulsed spark discharge, or laser-induced plasma.

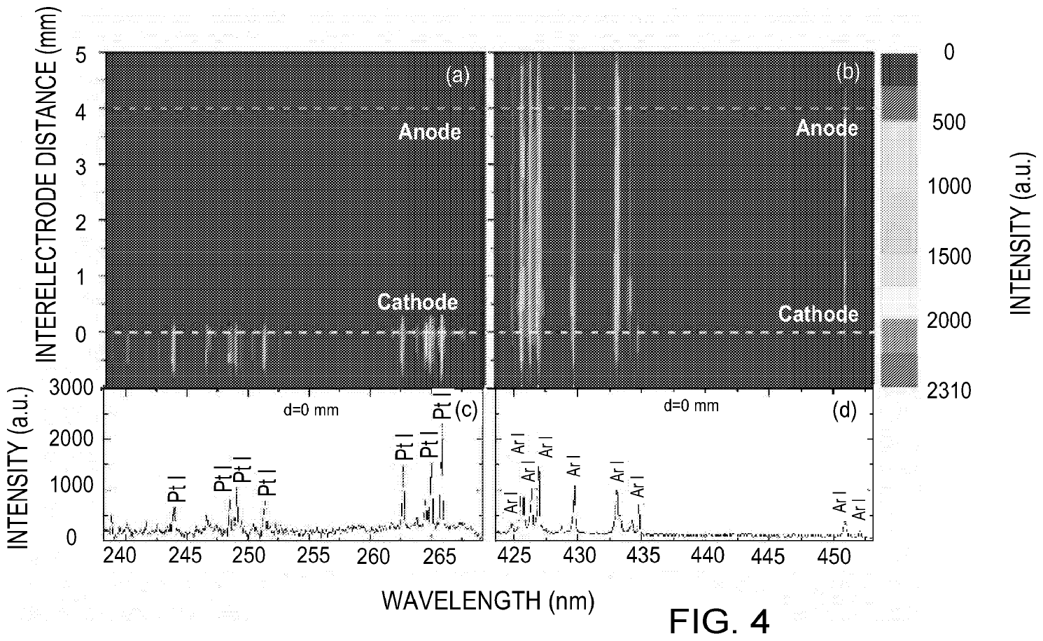

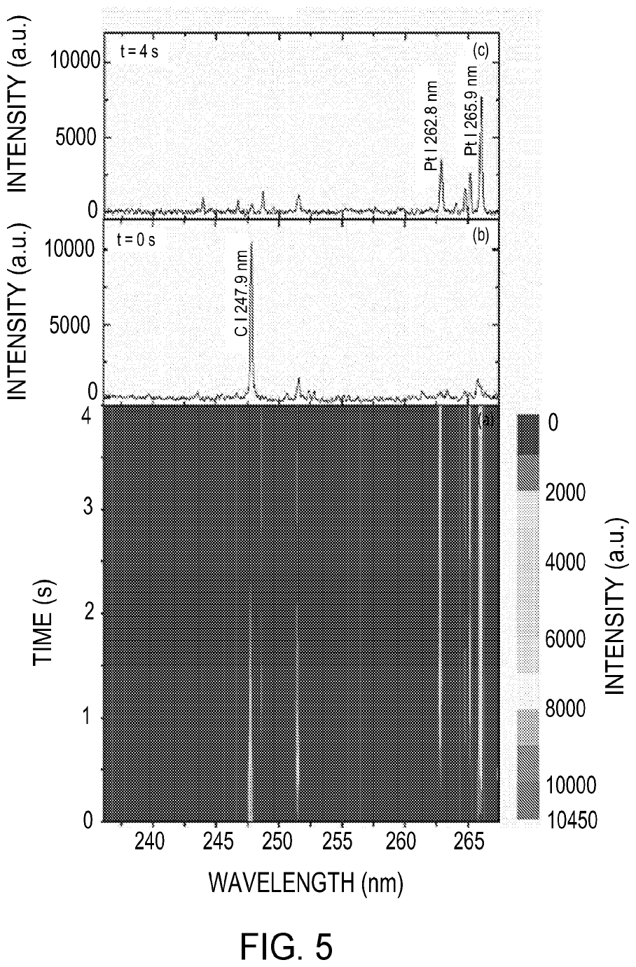

The spatial-temporal dynamics of the GD where probed to optimize the signal-to-noise ratio of the rf-GD system 10. FIGS. 4(a) and (b) show contour plots of the space-resolved emission spectra, acquired at different locations along the longitudinal axis of the two electrodes in the inter-electrode space in the absence of any analyte on the collection electrode. FIGS. 4(c) and (d) show the spectrum obtained at the collection electrode tip (at 0 mm). Several platinum and argon emissions were observed using one embodiment of the aerosol analysis system 10. The platinum emission signal from the collection electrode (i.e., cathode) 32B occurs mainly within the 1 mm of the ground electrode surface, with the highest signal appearing at the electrode tip. As shown, the argon emission signal appears across the entire inter-electrode gap. These measurements suggest that the excitation of atoms ejected from the cathode, through collisions with ions, electrons, or other atoms in the glow discharge plasma, mainly occurs near the cathode surface due to the high density of both negative and positive ions in this region. The region where platinum emission was observed matches the ‘negative glow’ (NG) region in a typical structure of low-pressure glow discharge. The NG region is the source of light used in GD-OES and may be used to acquire analytical information, according to various embodiments.

FIGS. 4(c) and (d) also show that most emission lines are from the neutral species, most likely due to the relatively low temperature of the glow discharge. Ionic emissions can be observed in GD for some elements with low ionization energies. The RF GD-OES system 10 provides fewer emission lines compared to laser-induced breakdown spectroscopy (LIBS) and spark microplasma emission spectroscopy. In addition, the line widths are narrower and molecular band emissions are limited. These factors can potentially lower the possibility of spectral interferences.

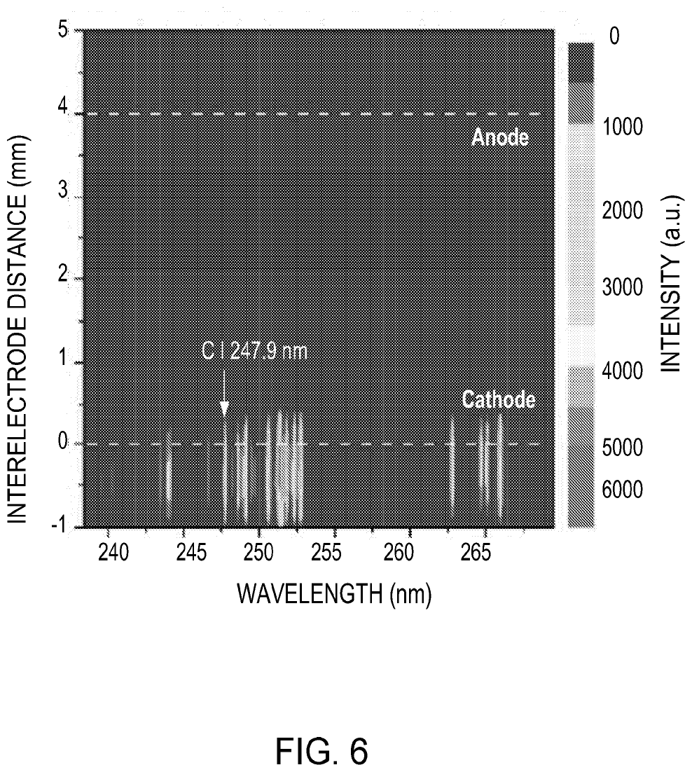

In various embodiments, the temporal characteristics of the analyte signal may be determined by acquiring time-resolved spectra with particles deposited on the collection electrode 32B. As glow discharge is a continuous plasma, during which the analyte is ablated layer by layer, the analyte signal is a function of time. FIG. 4(a) shows the color contour plot for the time-resolved spectra obtained after the glow discharge was initiated (e.g., at t=0, with a gate width of 0.5 s). FIGS. 4 (b) and (c) show the spectra obtained at t=0 s and t=4 s, respectively. The example carbon emission signal (C I 247.9 nm) is highest at t=0 s and then decreases with time, whereas the example platinum emission signals (Pt I 262.8 nm and Pt I 265.9 nm) appear at 0.5 s and then increase with time. At t=2 s, the carbon emission signal disappears, and the platinum emission signal reaches a maximum and remains unchanged after that. The decreasing carbon signal indicates that the sucrose particles were gradually ablated by the glow discharge. The amount of particulate carbon was predetermined to be 81 ng using Eq. (1). It takes approximately two seconds for complete ablation of the particulate sucrose (81 ng carbon). FIG. 6 shows the spatially resolved spectra acquired in the presence of particles deposited on the cathode tip. It is seen that the atomic emission from the ablated particles also occurs in the region near the collection electrode 32B. These spatial and temporal characteristics of the rf-GD system were used to optimize the signal-to-noise ratio and operating characteristics.

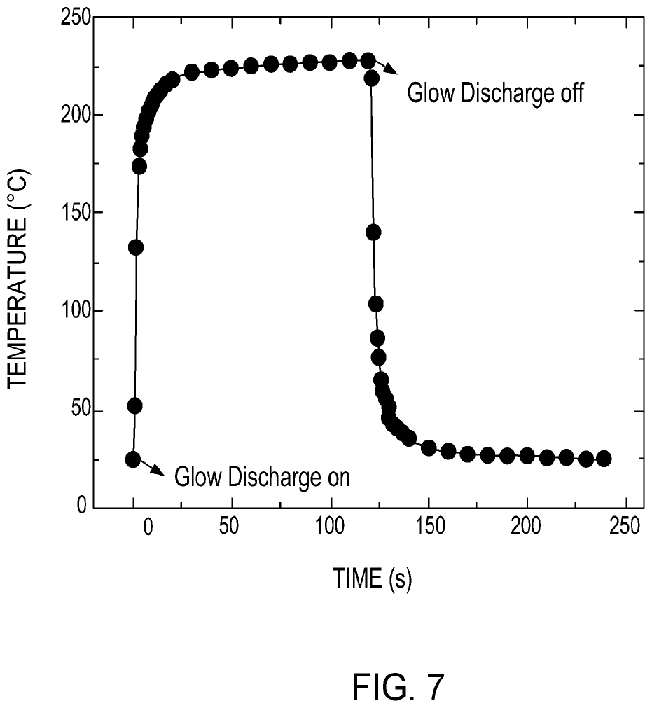

FIG. 7 shows variation of the temperature as a function of time after the glow discharge was turned on and then off. After the glow discharge is initiated, the cathode temperature rapidly increases to approximately 220° C. After about t=20 s, the temperature approaches the equilibrium value. The increasing electrode temperature is due to the energy transfer from the reactive species in the plasma (ions, electrons, and metastable species) to the electrode surface. FIG. 7 also shows that once the glow discharge is turned off, the electrode temperature drops to room temperature after approximately 30 s from radiative and convective cooling in the CAM 30. This rapid heating and cooling of the electrode assures short collection cycles. In at least one embodiment, the temperature of the collection electrode does not affect the particle collection characteristics of the CAM 30.

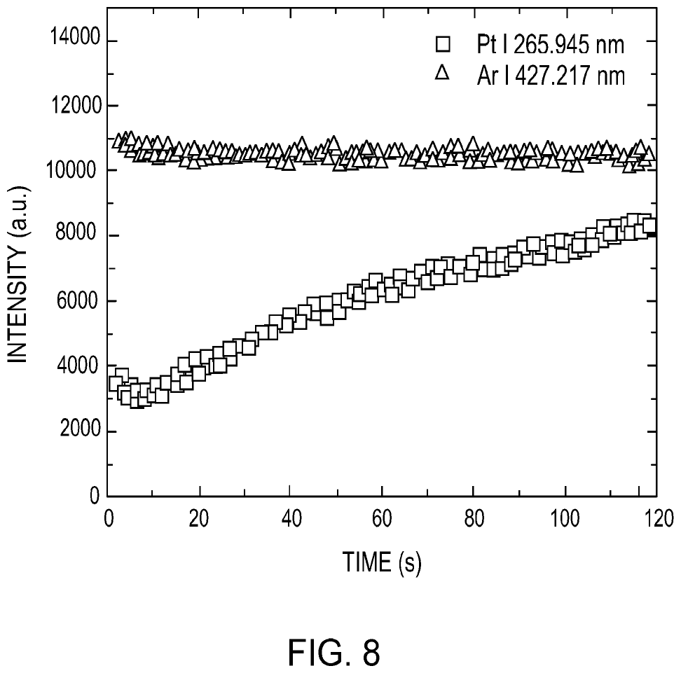

FIG. 8 shows variation of example Ar I and example Pt I signals as a function of time. In one embodiment, a glow discharge was continuously produced for 2 min during which the optical emission spectra were recorded every 0.5 s. As shown in FIG. 8, no significant variation was observed for the Ar I line (the relative standard deviation was 1.2% for Ar I).

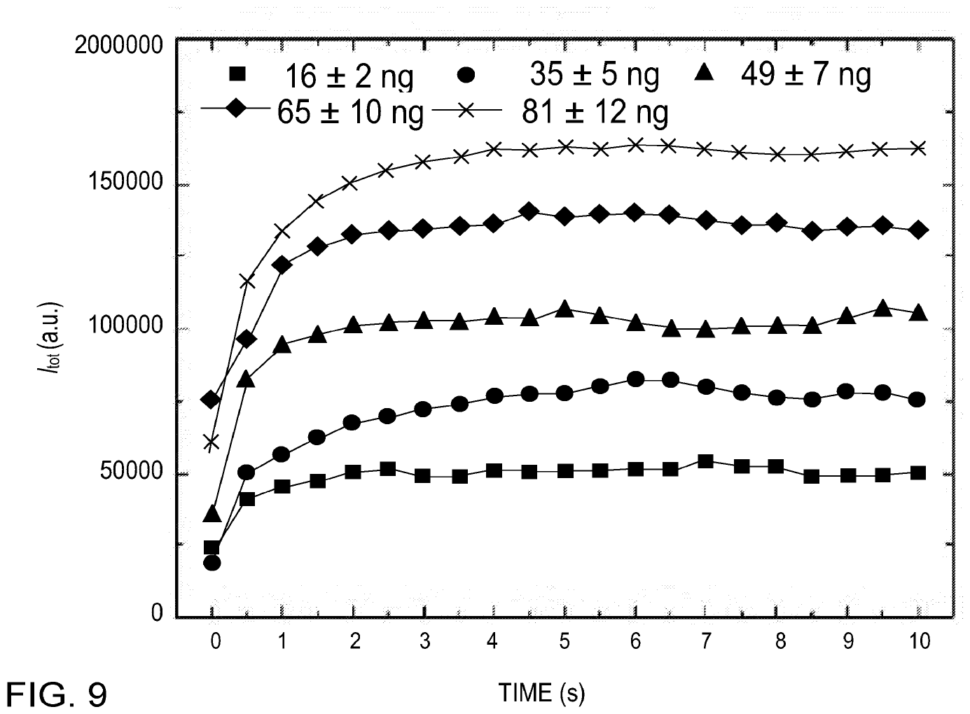

Calibration curves for different analytes were constructed by depositing a known particulate mass on the collection electrode, followed by measurement of emission signal as a function of time as described earlier. FIG. 9 shows change of cumulative carbon emission signal (C I 247.9 nm) as a function of time for different particulate loadings. The particulate mass on the electrode tip was varied by changing the collection time, which varied from 1 to 5 minutes. The cumulative carbon emission signal increases with time (and reaches a maximum and remains unchanged after several seconds), indicating that the particles collected on the electrode tip were continuously and completely ablated by the glow discharge. From FIG. 9, the time duration required for the complete ablation of the collected particulate carbon, total mass ranging from 16 ng to 81 ng, was approximately 2 seconds.

The time-dependent signal intensity I(t) of analyte from the glow discharge was integrated to obtain the total emission signal Iₜₒₜ, such that Iₜₒₜ=ƒ₀^{T}I(t)dt where T is the period for which the glow discharge was turned on. Therefore, Iₜₒₜ is the cumulative signal at time t. Using the data in FIG. 9, a calibration curve was constructed by plotting the integrated signal intensity Iₜₒₜ as a function of elemental mass (mₚ) deposited on the electrode tip. FIG. 10 shows representative calibration curves for C, Cd, Mn, and Na. The selected analytical emission line for each element was C I 247.8 nm, Cd I 508.6 nm, Mn I 403.1 nm, and Na I 589.0 nm. Calibration curves were described using a linear fit. Three sets of measurements were performed for each mass loading. Each data point on the calibration curve represents the average over three replicates.

According to one embodiment, the limit of detection (LOD) is estimated using 3σ criteria defined by the International Union of Pure and Applied Chemistry (IUPAC) as:

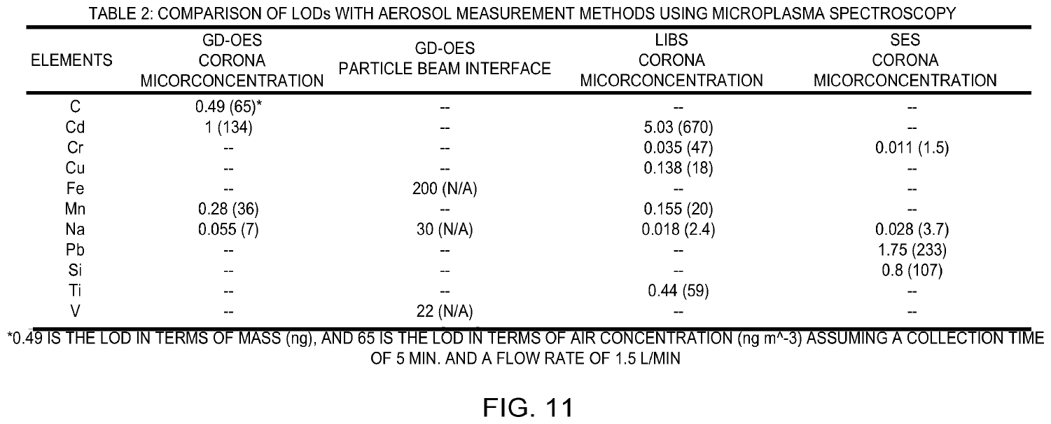

LOD=3σ/S (9)

where a is the standard deviation of the blank at the selected spectral region and S is the sensitivity given by the slope of the calibration curve. The mass LOD was in the range of 0.55-1.0 ng depending on elements analyzed, as listed in Table 1, shown in FIG. 2. The LOD in terms of air concentration was 7 to 134 ng M⁻³ at a flow rate of 1.51 min⁻¹ for a sampling time of 5 minutes. A lower LOD may be achieved by either increasing sampling time or flow rate. FIG. 11 shows the comparison of LODs resulted from different aerosol measurement methods including GD-OES, LIBS, and spark emission spectroscopy (SES). As shown, the LODs of the aerosol analysis system 10 and methods were significantly better than those from a particle beam interface GD-OES.

In one embodiment, the CAM 30 and glow discharge system of the aerosol collection system 14 can be coupled with mass spectrometry 56 to allow rapid chemical analysis of the sample by analyzing the ion's mass-to-charge ratio. In one embodiment, an aerosol sample is first collected onto the cathode 32B in the CAM 30. A glow discharge is generated between the cathode 32B and anode 32A in an argon bath. The sample deposited on the cathode 32B undergoes ionization through collision with the energetic positive ions generated in the glow discharge plasma. The sputtered atoms enter the negative glow region of the discharge and are subsequently ionized through collisions with the energetic argon atoms and electrons. The ionized fragments of the analytes are then introduced into a mass spectrometer 56 to obtain a mass spectrum of the sample. In one aspect, this embodiment allows for real-time particle collection and mass spectrometric analysis.

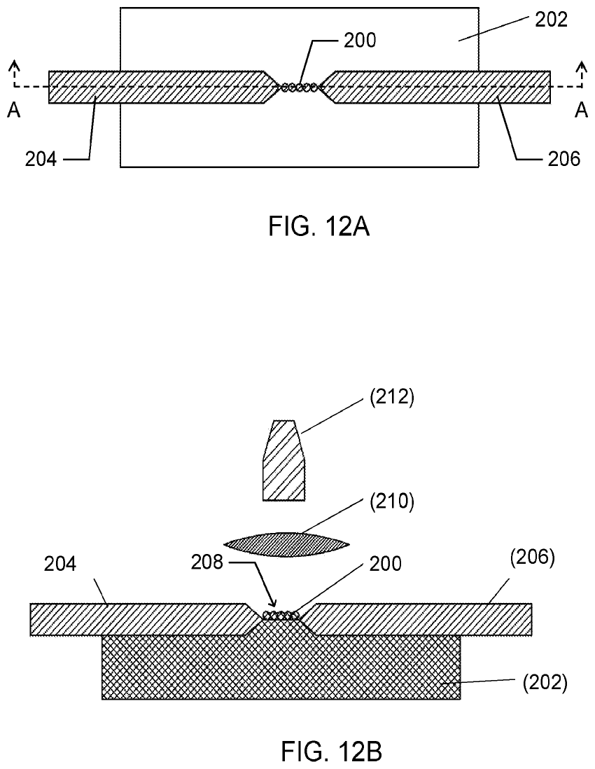

Additional embodiments of the aerosol analysis system 10 and methods disclosed herein are shown in FIGS. 12-16. FIG. 12A is a top view of another embodiment of the electrode assembly 100 of an embodiment of the aerosol analysis system 10 utilizing surface discharge, and FIG. 12B is a cross-sectional view of the embodiment, as viewed along line A-A. As shown, particles 200 are deposited on a nonconductive substrate 202 as a line using a slot impactor in the inter-electrode space between the two coaxial electrodes (e.g., an anode 204 and a cathode 206). In various embodiments, each of the electrodes may have a diameter in a range from a few microns (e.g. —2μm) to few millimeters (−5 mm). The tip radius may also vary and be in the range between few microns (e.g. ˜2μm) and few millimeters (−5 mm). The distance of the inter-electrode gap 208 varies with the length of the particle deposition area. In one embodiment, the inter-electrode gap 208 is approximately 5 millimeters. Also shown in this embodiment of the system 10 are a convex lens 210 and an optical fiber cable 212 that are aligned with the inter-electrode gap 208 to collect the atomic emission from the glow discharge.

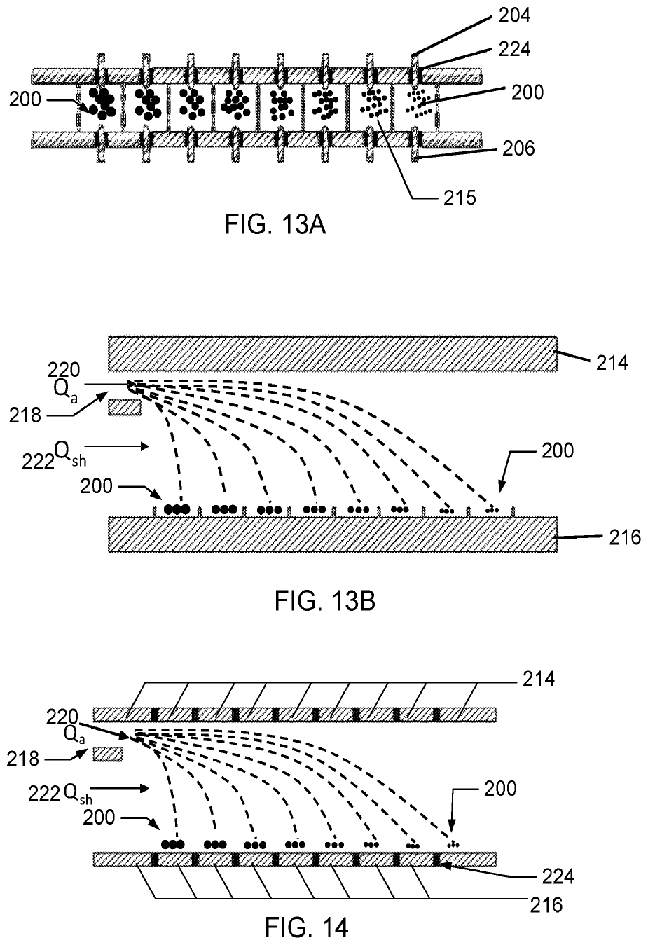

FIGS. 13A and 13B are a top view and side view of a multiplexed scheme of the electrode assembly 100 similar to that shown in FIGS. 12A-B. In particular, this embodiment has a rectangular geometry with a pair of rectangular electrodes 214 and 216 separated by a small distance 213 (typically a few millimeters). One electrode 214 is held at a classification voltage and the other electrode 216 is grounded. The separation electrodes 214 and 216 are used to separate particles 200 by their electrical mobility or size. An aerosol inlet 218 parallel to the top electrode 214 is provided to introduce electrically charged particles at a flow rate of Qₐ, indicated as 220. In various embodiments, the aerosol inlet 218 is a sheath flow inlet provided to introduce particle-free sheath flow. The voltage difference between the separation electrodes 214 and 216 provides a uniform electric field that separates the particles 200 based on their electrical mobility, indicated generally as Qₛₕ 222. The particles 200 deposit on the bottom collection electrode 216 at different locations depending on their electrical mobility, which is related to their size, due at least in part to the influence of the uniform electrical field. The bottom, grounded separation electrode 216 is divided into multiple sections 215; each section is electrically isolated from one another. In various embodiments, the sections may be electrically isolated by an air gap or an insulating material as shown in FIG. 14. FIG. 14 shows yet another embodiment of the electrode assembly 100 for size-resolved measurements using electrical mobility classification. The electrode assembly 100 is substantially similar to the embodiment shown in FIGS. 13A-B. This embodiment, however, includes an insulating material 224 disposed between each section 215 of the grounded electrode 216.

Each section 215 collects particles within a certain size/mobility range. For each section, two coaxial, planar microelectrodes (one anode 204 and the other cathode 206) are provided with similar configuration as in FIGS. 12A-B to create glow discharge along each section 215 of the collection electrode 216 surface. The glow discharge electrodes 204 and 206 are used to create the glow discharge and operate independent of the separation electrodes 214-216. In various other embodiments, an electrode arrangement similar to that shown in FIGS. 13A-B or 14 may also be provided in an annular, round, or cylindrical geometry. Other geometries and shapes may also be used.

When used to analyze an airborne particulate sample, the particles 200 are collected on the bottom collection electrode 216 for a predetermined amount of time. Once the collection is complete, the aerosol (Qₐ) 220 and sheath (Qₛₕ₎ 222 flows are turned off. A radio-frequency glow discharge is sequentially initiated between pairs of planar electrodes 204 and 206 in each section 215 of the bottom collection electrode 216. This allows the sequential measurement of the size-resolved elemental composition of an aerosol sample.

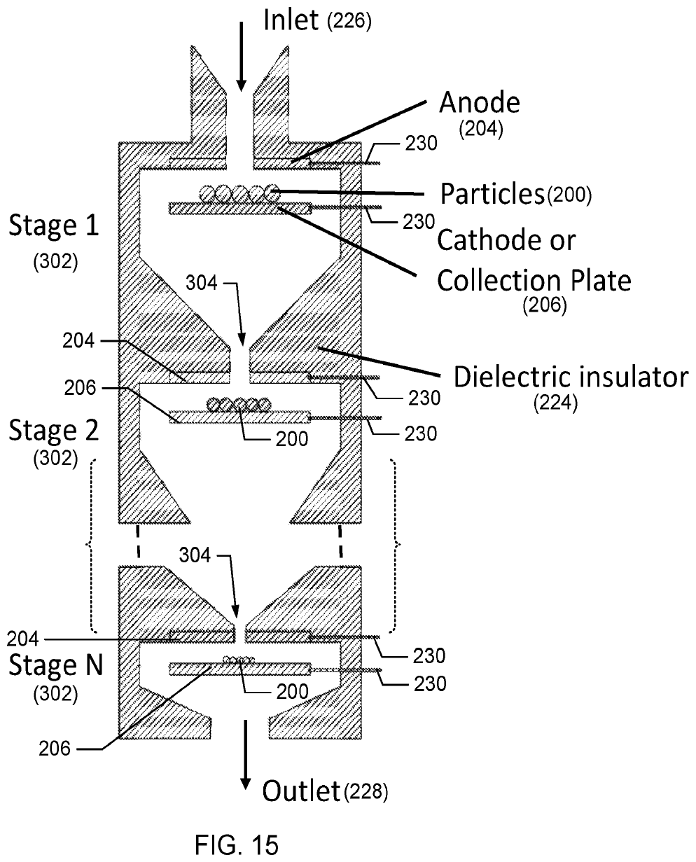

FIG. 15 is a cross-sectional view of another embodiment of an electrode assembly configured as a cascade impaction system 300 to separate particles based on their aerodynamic size. This embodiment allows measurement of size-fractionated elemental concentrations of aerosols.

The cascade impaction system 300 includes an inlet 226 where particles may enter the system before or during analysis. The system 300 also includes an outlet 228 where the particles may be removed or purged from the system. As shown, the cascade impactor consists of two or more stages 302. Each stage 302 includes one or more micro-orifice or nozzles 304 and collection substrates 206. Each nozzle 304 includes an anode electrode 204 that faces the collection substrate 206, which functions as a cathode. The anode electrode 204 and cathode substrate 206 may be further engaged to one or more electrical connectors, leads, or wires 230.

Typically, an aerosol flow is introduced into the cascade impactor at a fixed flow rate. Particles larger than a certain aerodynamic size (which decreases for each stage going from top to bottom) are collected on the collection substrate. Particles smaller than the aerodynamic size for that stage escape with the flow and enter the second or subsequent stage. The aerodynamic size cut for each stage is successively reduced by controlling the diameter of the impaction nozzle and is given by:

$${d}_{p 50} = \sqrt{\frac{9 η {D}_{j ( {Stk}_{50} )}}{{ρ}_{p} {UC}_{c}}} \qquad ( 10 )$$

η is air viscosity, Dⱼ is diameter of the jet, ρₚ is particle density, U is flow velocity, C_{c} is slip correction factor.

In one aspect, the disclosed configuration for the cascade impactor 300 allows generation of low-pressure radio frequency glow discharge in each stage for elemental measurement, which is not available in conventional cascade impactors. As shown, the body of the cascade impaction system 300 is composed of a dielectric insulating material. After a desired period of particle collection on the impactor substrate 206, a low-pressure glow discharge is created between the anode electrode 204 of the nozzle 304 and the cathode collection substrate 206 in Ar bath. This permits ablation of the deposited particulates, and generates atomic emissions from the analyte of interest. Optical access for collecting, observing, or transmitting, the atomic emission signal is provided at each stage 302 to collect and analyze the atomic emission spectra from each particle grouping.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A portable system for the spectroscopic analysis of aerosol particles, the system comprising:
an aerosol collection device further comprising:
a housing defining an inlet and an outlet;
a corona electrode disposed proximally to the inlet; and,
a ground electrode disposed proximally to the outlet; wherein the ground electrode is aligned coaxially with the corona electrode and is separated from the corona electrode by a gap;
a high voltage source in communication with the corona electrode;
a radio frequency power supply in communication with the corona electrode;
wherein the corona electrode is held at a bias voltage provided by the high voltage source;
wherein a glow discharge is generated at the corona electrode by the radio frequency power supply; and, wherein the glow discharge ablates aerosol particles collected on ground electrode.

2. The system of claim 1, wherein the corona electrode has a conical distal end terminating at a tip.

3. The system of claim 1, wherein the ground electrode has a flat distal end providing a surface for aerosol particle accumulation.

4. The system of claim 3, wherein the ground electrode further comprises a sidewall sheath and the sidewall sheath having a high dielectric constant to prevent deposition of the particles on the sidewall.

5. The system of claim 1 wherein the inlet is in communication with an aerosol generation system.

6. The system of claim 1 wherein the housing is filled with a noble gas.

7. The system of claim 6 wherein the noble gas is provided through the inlet.

8. The system of claim 1 wherein the outlet is in fluid communication with a vacuum source to provide a constant flow rate through the housing.

9. The system of claim 1 wherein the aerosol generation system comprises at least one of:
an atomizer;
a diffusion dryer;
a differential mobility analyzer;
a neutralizer; and,
an electrostatic precipitator.

10. The system of claim 1 further comprising an optical spectrograph system; wherein the optical spectrograph system records an emission spectrum resulting from the ablation of aerosol particles.

11. The system of claim 10 wherein the optical emission spectrograph system further comprises:
a lens;
a spectrograph; and,
a gated intensified charge couple device.

12. The system of claim 1 further comprising an optical spectrograph system;
wherein the optical spectrograph system records a mass spectrum for the aerosol particles.

13. (canceled)

14. A method for collecting and analyzing aerosol particles in a portable apparatus; the method comprising:
providing a housing having an inlet and an outlet, wherein the aerosol particles flow from the inlet to the outlet;
applying a bias voltage to a corona electrode positioned near the inlet and in a flow path of the aerosol particles;
holding a ground electrode to a ground potential, wherein the ground electrode is coaxial with the corona electrode, positioned near the outlet, and spaced from the corona electrode by a gap;
providing a constant flow of the aerosol particles to the housing;
providing a glow discharge current to the corona electrode using a radio frequency power supply, wherein the glow discharge ablates aerosol particles accumulated on the ground electrode;
collecting emissions produced by the ablation of the accumulated aerosol particles; and, analyzing an emissions spectrum of the ablated aerosol particles.

15. (canceled)

16. (canceled)

17. (canceled)

18. A portable system for the spectroscopic analysis of aerosol particles, the system comprising:
an aerosol collection device further comprising:
a ground electrode and a high-voltage electrode assembly for particle separation, wherein the high-voltage electrode is disposed facing the ground electrode and separated by a separation gap;
one or more pairs of glow discharge electrodes, wherein the glow discharge electrodes comprise an anode electrode and a cathode electrode positioned on the ground electrode; wherein the anode electrode is aligned with a cathode electrode positioned on the ground electrode and separated from the cathode electrode by a gap defining a particle deposition area;
a radio frequency power supply in communication with each anode electrode of glow discharge electrodes pairs;
wherein a glow discharge is generated at each anode electrode by the radio frequency power supply; and,
wherein the glow discharge ablates aerosol particles collected on the ground substrate in the particle deposition area.

19. The system of claim 18 further comprising:
a high voltage source in communication with the high-voltage electrode; and
wherein a voltage difference across the high-electrode voltage and the ground electrode separates the particles by electrical mobility or size.

20. A portable system for the spectroscopic analysis of aerosol particles, the system comprising:
an aerosol collection device further comprising:
a dielectric housing, defining one or more stages, each stage separated by a micro-orifice inlet;
a cathode electrode positioned within each of the one or more stages of the dielectric housing;
an anode electrode positioned proximal to the micro-orifice inlet of each stage and aligned facing the cathode electrode; wherein the anode electrode is separated from the cathode electrode by a gap defining a particle deposition area;
a radio frequency power supply in communication with the anode electrode;
wherein a glow discharge is generated at the anode electrode by the radio frequency power supply; and,
wherein the glow discharge ablates aerosol particles collected in the particle deposition area.

21. The system of claim 20, wherein each micro-orifice inlet has a diameter smaller than a preceding inlet such that the particles within each stage differ in size.

22-23. (canceled)

24. A method for collecting and performing mass spectrometric analysis of aerosol particles; the method comprising:
providing a housing comprising an inlet and an outlet, wherein the aerosol particles flow from the inlet to the outlet;
providing argon gas to the housing to form an argon gas atmosphere;
applying a bias voltage to an anode positioned near each inlet coaxially along the flow path of the aerosol particles;
holding a coaxial cathode to a ground potential and spaced from the anode by a gap;
collecting the aerosol particles from the flow on a flat tip of the cathode;
applying potential to the anode to induce an atmospheric glow discharge between the electrodes, wherein the glow discharge ablates the aerosol particles collected on the cathode surface generating an atomized species, and wherein the atomized species further undergo ionization in the glow discharge;
transporting the ionized species to an inlet of a mass spectrometer; and,
obtaining a mass spectrum data of the ionized species.

25. The method of claim 24, wherein the mass spectrum data comprises mass-to-charge ratio of the ionized species.

26. The method of claim 24, wherein the mass spectrum data comprises an intensity versus mass-to-charge ratio.
